(19) United States
(12) Patent Application Publication
(10) Pub. No.: US 2003/0108069 A1
(43) Pub. Date: Jun. 12, 2003

(54) Interface device

(76) Inventor: Shigeki Yamada, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/199,905

(22) Filed: Jul. 19, 2002

(30) Foreign Application Priority Data
Dec. 10, 2001 (JP) 2001-376354

(51) Int. Cl. H04J 3/04; H04L 12/28

(52) U.S. Cl. 370/535; 370/389

(57) ABSTRACT

In an interface device connecting packet multiplexing networks and a time division multiplexing channel network having different multiplexing systems, and a network system, an address table associates a destination address with a broadcast identifier, a group identifier, and a port identifier uniquely indicative of a virtual concatenation channel for transmitting a packet to be stored, a tag generator of an extended header terminator, based on this address table, adds the broadcast identifier, the group identifier, and the port identifier to a received packet to be transmitted. A time division multiplexer of a frame processor having received this packet performs mapping on a virtual concatenation channel corresponding to the port identifier, and broadcasts or multicasts the packet according to the broadcast identifier and the group identifier.

### BACKGROUND OF THE INVENTION

1. Field of the Invention

The present invention relates to an interface device, and in particular to an interface device which mutually connects packet multiplexing networks and a time division multiplexing channel network having different multiplexing systems, and a network system.

A network system for long distance/high-speed transmission manages information by a time-division-multiplexed channel or path to be transmitted. For example, PDH (Plesiochronous Digital Hierarchy) and SHD (Synchronous Digital Hierarchy) respectively multiplex the information on a bit-by-bit or byte-by-byte basis to be transmitted.

On the other hand, a transmission system for advanced service such as Quality of Service (QOS), broadcast, and multicast, and a network system of a user using a LAN (Local Area Network) multiplex the information on a packet basis (packet multiplexing) to be managed and transmitted.

Recently, also in a WAN (Wide Area Network), needs for packet processing have been increased more and more in order to enhance an affinity with the LAN. At this time, it is important that time division multiplexing transmission channels for long distance/high-speed transmission which mutually connect remote LAN's, for example, maintain advanced services in the communication where an accommodated packet is multiplexed.

2. Description of the Related Art

Most of conventional routers or switches performing packet multiplex processing have treated a physical transmission channel as a channel. That is, only a limited number of devices have supported an interface which accommodates a plurality of channels in a single physical interface by time division multiplexing. In addition, such limited number of devices can successfully accommodate to only a low-speed interface, not a high-speed interface.

On the other hand, the prior art system processing time division multiplexing (TDM) channels has only multiplexed or switched over multiplexing channels or paths on a bit-by-bit or byte-by-byte basis. This system has hardly treated a packet mapped in the channel or the path. Thus, the packet is not processed in a time division multiplexing channel network which performs a long distance transmission. Therefore, it is difficult to construct a WAN, which can flexibly accommodate to the advanced service, such as LAN.

FIG. 15 shows an arrangement of a general WAN network. In this WAN network, packet multiplexing networks 701-703 are connected with each other with a time division multiplexing channel network 500. In this example, the packet multiplexing networks 701-703 are LAN networks, and the time division multiplexing network 500 is an SDH network.

The LAN network 701 is connected to the time division multiplexing channel network 500 through an interface device 110_1, a time division multiplexing switch 300, and an SDH interface 400 (400_1-400_n). The LAN networks 702 and 703 are similarly connected to the time division multiplexing channel network 500.

Hosts 801, 802, . . . , 803, 804, . . . , 805, 806, . . . are respectively connected to the LAN networks 701-703.

Hereinafter, an operation for transmitting a packet 71 from the host 801 to the host 803 will be described.

The packet 71 is transmitted to the interface device 110_1 through the LAN network 701 and a channel terminator 200 which terminates this network. This interface device 110_1 maps the packet 71 on a virtual concatenation channel VC#1 corresponding to e.g. a bandwidth of the packet 71.

The channel VC#1 is switched over by the time division multiplexing switch 300 to be transmitted to a time division multiplexing switch 301 through the SDH interface 400_1, the time division multiplexing channel network 500, and the SDH interface 401_1.

The time division multiplexing switch 301 switches over the channel VC#1 to be provided to the interface device 111_1. This interface device 111_1 de-maps the packet 71 from the channel VC#1, and transmits the packet 71 to the LAN network 702 through the channel terminator 201. The destination host 803 receives the packet 71.

FIG. 16 specifically shows the prior art interface device 110 shown in FIG. 15. This interface device 110 is composed of a packet switch 120 and a virtual concatenation frame processor 130 mutually connected with physical channels 60.

The packet switch 120 receives the packet 71 (not shown) from the channel terminator 200 which is a physical interface for terminating the packet multiplexing network 701. Then, the packet switch 120 analyzes a header of the packet 71, and distributes the packet to the virtual concatenation channel (usually including a channel which is not concatenated) of the frame processor 130 corresponding to the bandwidth of the packet.

If the packet 71 is a unicast packet, a broadcast packet, or a multicast packet, then the packet switch 120 distributes the packet according to the type of packet.

The frame processor 130 maps the received packet 71 by the virtual concatenation channel, and provides the mapped packet to the time division multiplexing switch 300 through time division multiplexing channels 50.

Conversely, in the interface device 110, the frame processor 130 time-division-demultiplexes the time division multiplexing channels received from the time division multiplexing switch 300 into the virtual concatenation channels, and de-maps the packet mapped to these channels. The packet switch 120 multiplexes the de-mapped packet to be transmitted to the packet multiplexing network 701 through the channel terminator 200.

In addition, the channel or path of the frame processor 130 is set to a channel corresponding to a bandwidth (rate) of a packet to be transmitted. This makes it possible to construct a flexible time division multiplexing channel network corresponding to the advanced services.

Hereinafter, an example in which a channel bandwidth is changed will be described with respect to the case where the time division multiplexing channel network comprises an SDH interface, and its bit rate is 2.488 Gbps (STM-16).

For the SDH interface, a usual concatenation and a virtual concatenation defined in ITU-T recommendation G.709 such as VC-3-Xv are defined.

In this virtual concatenation, 49 types (52 Mbps, 104 Mbps, 2.488 Gbps) of channel rates (bandwidths) can exist between 52 Mbps and 2.488 Gbps at 52 Mbps intervals.

The frame processor 130 sets e.g. virtual concatenation channels 60 (50 Mbps, 600 Mbps, . . . , 150 Mbps in FIG. 16) of a bandwidth required by a packet as a channel corresponding to a packet destination, thereby enabling communication in the bandwidth required on a packet basis.

However, the virtual concatenation frame processor 130 is required to process channels with a plurality of rates. To integrate, in a single a single integrated circuit, the packet switch 120 and a circuit which has such a variety of rates and many channels and performs frame processing is difficult to be realized in view of a circuit scale, an I/O, and a power consumption, and cost of parts is increased.

As measures against the above-mentioned problems, there is a system for dividing channels. However, there exist plural types of physical interfaces between in-device blocks for mapping a packet on a channel according to a bandwidth and a connection mode. As a result, it is required to prepare hardwares, which are different depending on the bandwidth provided to users and the connection modes.

For example, in the prior art, when packets are multiplexed (mapped) for the time division multiplexing (hereinafter, occasionally abbreviated as TDM) channel on which the bandwidth and the number of channels are both variable, interfaces of a packet processor and a channel processor adopt any one of the following techniques (1)-(4).

(1) Physical interfaces having the maximum bandwidth that can be realized on the TDM channel side are provided as many as the maximum number of channels that can be realized on the individual TDM side.

(2) The physical interfaces of the maximum number of channels that can be realized on the TDM channel side are provided. In this case, the individual channel bandwidth is smaller than the maximum bandwidth that can be realized on the TDM side.

(3) The physical interface for the maximum bandwidth that can be realized on the TDM side is provided. In this case, the number of physical interfaces is smaller than the maximum number that can be realized on the TDM side.

(4) The above-mentioned (2) or (3) is selectively used according to the channel bandwidth on the TDM side.

In case of (1), the number of I/O's of the integrated circuits, a part mounting area, and power consumption increase. In case of (2) and (3), the performance of the packet switch 120 and the time division multiplexing switch 300 is limited, which leads to a bottleneck and causes a suppression of a system performance. In case of (4), as described above, a plurality of in-device interfaces are required, which causes complication of devices and an increase in menu of units constituting the device.

### SUMMARY OF THE INVENTION

It is accordingly an object of the present invention to provide an interface device which mutually connects packet multiplexing networks and a time division multiplexing channel network, and a network system, wherein a circuit construction can be easily realized, a bandwidth and the number of channels are variable, and broadcast and multicast functions are maintained.

In order to achieve the above mentioned object, an interface device according to the present invention comprises: an address table in which a destination address of a packet is associated with a port identifier uniquely indicative of time division multiplexing channels for transmitting the packet; a tag generator for adding to a received identifier a port identifier corresponding to a destination address of the packet based on the address table; and a time division multiplexer for mapping the packet from the tag generator to a time division multiplexing channel corresponding to the port identifier added thereto. (claim 1)

In order to simply describe the principle of the present invention, an example in which an interface device of the present invention is arranged between a packet multiplexing network and a time division multiplexing channel network will be described.

A remote address, a local address, a destination address of a packet, and a source address will now be described.

A remote address is an address of a host on the time division multiplexing channel network side when it is seen from the interface device concerned. A local address is an address of a host on the packet multiplexing network side. Therefore, the source address of a packet directed from the packet multiplexing network side to the time division multiplexing channel network side is the local address, and its destination address is the remote address. Conversely, the source address of the packet directed from the time division multiplexing channel network side to the packet multiplexing network side is the remote address, and its destination address is the local address.

Hereinafter, as appropriate, it is occasionally indicated that the destination address or the source address of the packet is either the remote address or the local address. However, it does not always mean that “remote” is a remote address and “local” is a near address.

In an address table (remote address table), a destination address (remote address) of a packet received from the packet multiplexing network side and a port identifier uniquely indicative of a time division multiplexing channel which transmits the packet are associated with each other and are preliminarily registered.

A tag generator adds to a packet a port identifier corresponding to a destination address of the packet based on the address table (remote address table). A time division multiplexer maps the packet received from the tag generator to a time division channel (frame) corresponding to the port identifier added to the packet.

Thus, a logical switching of the received packet enables a circuit construction of the interface device to be simplified, and time division channel processing in which the number of channels is variable to be performed.

Additionally, in the present invention according to the above-mentioned invention, the port identifier may correspond to a concatenation channel over which a plurality of time division multiplexing channels are concatenated, and the time division multiplexer may map the packet to a concatenation channel corresponding to the port identifier added to the packet. (claim 2)

That is, it is possible to make the time division multiplexing channels as a channel in which a plurality of channels are concatenated. The time division multiplexer maps a packet to a concatenation channel corresponding to a port identifier added to the packet. As this concatenation channel, for example, a channel composed of a usual concatenation and a virtual concatenation in an SDH frame can be used.

This enables time division frame processing in which a bandwidth of time division multiplexing channels are variable and the number of channels is variable as well. That is, the bandwidth of the time division multiplexing channels can be arbitrarily designated with e.g. a predetermined bandwidth as the minimum unit.

Additionally, in the present invention according to the above-mentioned invention, the tag generator may add a broadcast identifier to the packet when the packet is a broadcast packet, and the time division multiplexer may delete the broadcast identifier from the packet, and then transmit the packet to the time division multiplexing channels corresponding to all ports. (claim 3)

This makes it possible to perform processing corresponding to the broadcast packet.

Additionally, in the present invention according to the above-mentioned invention, the time division multiplexer may transmit the packets to all of the time division multiplexing channels when the received packet is a broadcast packet. (claim 4)

That is, the time division multiplexer determines whether or not a packet is a broadcast packet. When the packet is a broadcast packet, the packet is transmitted to all of the time division multiplexing channels. This makes it possible to perform processing corresponding to the broadcast packets as well.

Additionally, in the present invention according to the above-mentioned invention, the tag generator may discard a packet whose address (remote address) is not registered in the address table (remote address table) and is defined as a destination address. (claim 5)

Thus, it is avoided that a packet not directed to the host on the time division multiplexing channel network side is transmitted to the time division multiplexing channel network side. That is, packet filtering is possible.

Additionally, the present invention according to the above-mentioned invention may further comprise: a time division demultiplexer for adding a port identifier of a terminated time division multiplexing channel to a packet de-mapped from the time division multiplexing channel; and a tag terminator for associating a source address (remote address) of the packet from the time division demultiplexer with the added port identifier to be registered or updated in the address table (remote address table). (claim 6)

That is, the time division demultiplexer de-maps a packet from the time division multiplexing channels, and adds to the de-mapped packet a port identifier corresponding to the time division multiplexing channels. The tag terminator associates a source address (remote address) of the packet with a port identifier, and registers them in an address table (remote address table).

This makes it possible to autonomously register correspondence between a source address (remote address) and a port identifier in an address table (remote address table).

Additionally, the present invention according to the above-mentioned invention may further comprise a time division demultiplexer for de-mapping a packet from a time division multiplexing channel terminated; and a second address table (local address table) in which a destination address (local address) of the packet is registered when the address table (remote address table) is defined as a first address table, the tag terminator may discard a packet whose destination address is not registered in the second address table of the packets received from the time division demultiplexer. (claim 7)

This makes it possible to discard a packet which is not registered in a second address table (local address table) of the packets directed to the packet multiplexing networks. That is, packet filtering is made possible.

Additionally, in the present invention according to the above-mentioned invention, the tag terminator may not discard a broadcast packet from the time division demultiplexer. (claim 8)

Additionally, in the present invention according to the above-mentioned invention, the tag generator may register a source address (local address) of a packet in the second address table (local address table). (claim 9)

This makes it possible to autonomously register or update a host address (local address) on the packet multiplexing network side in a second address table (local address table).

Additionally, the present invention according to the above-mentioned invention may further comprise a port group management table in which a group identifier is associated with a port identifier, the address table (first address table and remote address table) further storing a group identifier associated with the destination address (remote address), the tag generator further referring to the address table (first address table and remote table), and adding the group identifier corresponding to the destination address (remote address) of the received packet to the packet. The time division multiplexer may refer to the port group management table and may transmit the packet to the time division multiplexing channels corresponding to all the port identifiers associated with the group identifier added to the packet. (claim 10)

This makes it possible to transmit a packet to the time division multiplexing channel network side by means of multicasting based on a port group management table. It is to be noted that when group identifiers are associated with all of the port identifiers in the port group management table, the time division multiplexer broadcasts a packet.

Additionally, the present invention according to the above-mentioned invention may further comprise a port group management table in which a group identifier is associated with a port identifier. The time division multiplexer may refer to the port group management table, and transmit the packet to time division multiplexing channels corresponding to all port identifiers associated with a group identifiers added to a received packet. (claim 11)

This makes it possible to transmit a packet to the time division multiplexing channel network side by means of multicasting. It is to be noted that in this case, any means for adding a group identifier to a packet may be employed.

Additionally, the present invention according to the above-mentioned invention may further comprise a port group management table in which a group identifier is associated with a port identifier, the address table (first address table and remote address table) may further store the group identifier associated with the destination address (remote address). The time division demultiplexer may refer to the port group management table, and may further add to the packet, the group identifier corresponding to the port identifier. The tag terminator may associate a source address (remote address) of the packet with the added group identifier to be registered or updated in the address table (first address table and remote address table). (claim 12)

That is, a port group management table is further provided, and this management table stores a group identifier and a port identifier to be associated with each other. In addition, an address table (remote address table) further stores a source address (remote address) and a group address to be associated with each other.

The time division demultiplexer retrieves a group identifier to be associated with the port identifier from the port group management table, and adds the group identifier to the packet to be transmitted.

The tag terminator associates a source address (remote address) of the packet with the added group identifier, and registers or updates them in a first address table (remote address table).

This makes it possible to further associate a source address (remote address) with a group identifier, and register or update them in a first address table (remote address table). That is, it is possible to autonomously register or update a group identifier of a host of a remote address in a remote address table.

Additionally, in the present invention according to the above-mentioned invention, the tag terminator may not discard a multicast packet from the time division demultiplexer. (claim 13)

Thus, it can be avoided that a multicast packet which is not registered in the first address table (remote address table) is discarded.

Additionally, the present invention according to the above-mentioned invention may further comprise, when the time division multiplexer is defined as a first time division multiplexer, a second time division multiplexer for time division multiplexing channels from a plurality of first time division multiplexers. (claim 14)

That is, it becomes possible for the second time division multiplexer to multiplex a plurality of time division multiplexing channels from a first time division multiplexer and to make the channels high-speed time division multiplexing channels.

For example, a plurality of first time division multiplexers may map the received packets on the time division multiplexing channels, and the second time division multiplexer may further time-division-multiplex the mapped time division multiplexing channels into the high-speed time division multiplexing channels.

Additionally, the present invention according to the above-mentioned invention may further comprise, when the time division demultiplexer is defined as a first time division demultiplexer, a second time division demultiplexer at a preceding stage of the first time division demultiplexer and a packet multiplexer between the first time division demultiplexer and the tag terminator. (claim 15)

That is, the second time division demultiplexer can provide the first time division demultiplexer the time division multiplexing channels obtained when the high-speed time division multiplexing channels are time-division-demultiplexed. Furthermore, the packet multiplexer can multiplex the packet from the first time division demultiplexer, and provide a higher-speed packet multiplexing to the tag terminator.

For example, the second time division demultiplexer demultiplexes the high-speed time division multiplexing channels into the time division multiplexing channels. A plurality of first time division demultiplexers can time-division-demultiplex (de-map) the packets mapped on the time division multiplexing channels demultiplexed, for example, the virtual concatenation frame.

Then, it becomes possible that the packet demultiplexed from each of the first time division demultiplexers is multiplexed and is transmitted to the tag terminator.

This makes it possible to provide an interface from a higher-speed time division multiplexing channel network to a packet multiplexing network.

Furthermore, in the present invention according to the above-mentioned invention, the time division multiplexing channel may comprise a PDH channel or an SDH channel. (claim 16) That is, the interface device according to the present invention can correspond to the PDH channel or SDH channel.

Additionally, in order to achieve the above-mentioned object, a network system according to the present invention comprises: the first packet multiplexing network; the first interface device according to claim 1 connected to the first packet multiplexing network; a time division multiplexing channel network connected to the first interface device; a second interface device according to claim 1 connected to the time division multiplexing channel network; and a second packet multiplexing network connected to the second interface device. (claim 17)

This makes it possible to construct e.g. a wide area packet multiplexing network (LAN network), that is, a WAN network.

### BRIEF DESCRIPTION OF THE DRAWINGS

FIG. 1 is a block diagram showing a basic arrangement of embodiments (1) and (2) of an interface device according to the present invention;

FIG. 2 is a block diagram showing an arrangement of an extended header terminator in the embodiment (1) of the interface device according to the present invention;

FIG. 3 is a diagram showing a packet example in the embodiment (1) of the interface device according to the present invention;

FIG. 4 is a block diagram showing an arrangement of a virtual concatenation frame processor in the embodiment (1) of the interface device according to the present invention;

FIGS. 5A-5C are block diagrams showing an arrangement of a network to which the embodiments (1) and (2) of the interface device according to the present invention are applied;

FIG. 6 is a flow chart showing an example of an operation procedure for a tag generator in the embodiment (1) of the interface device according to the present invention;

FIG. 7 is a flow chart showing an example of an operation procedure for a tag terminator in the embodiment (1) of the interface device according to the present invention;

FIG. 8 is a block diagram showing an arrangement of an extended header terminator in the embodiment (2) of the interface device according to the present invention;

FIG. 9 is a diagram showing a packet example in the embodiment (2) of the interface device according to the present invention;

FIG. 10 is a block diagram showing an arrangement of a virtual concatenation frame processor in the embodiment (2) of the interface device according to the present invention;

FIG. 11 is a flow chart showing an example of an operation procedure for a time division multiplexer in the embodiment (2) of the interface device according to the present invention;

FIG. 12 is a flow chart showing an example of an operation procedure for a time division multiplexer in the embodiment (2) of the interface device according to the present invention;

FIG. 13 is a flow chart showing an example of an operation procedure for a time division demultiplexer in the embodiment (2) of the interface device according to the present invention;

FIG. 14 is a flow chart showing an example of an operation procedure for a tag terminator in the embodiment (2) of the interface device according to the present invention;

FIG. 15 is a block diagram showing an arrangement of a general WAN network; and

FIG. 16 is a block diagram showing an arrangement of a prior art interface device.

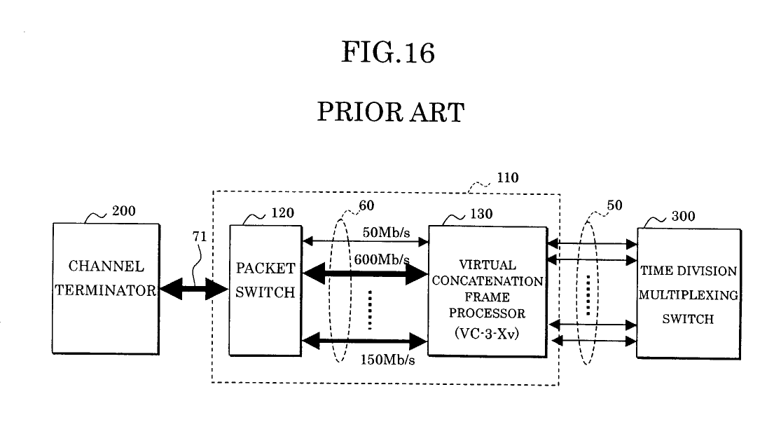

Throughout the figures, like reference numerals indicate like or corresponding components.

### DESCRIPTION OF THE EMBODIMENTS

An interface device according to the present invention is applicable to a packet with a header into which a destination address and a source address are inserted. Hereinafter, embodiments in case where a packet of Ethernet is treated will be described.

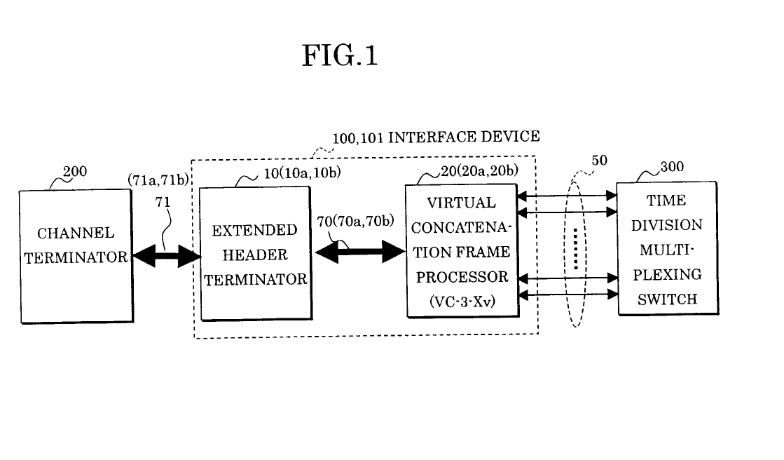

FIG. 1 shows a basic arrangement of an interface device 100 according to the present invention. This interface device 100 is composed of an extended header terminator 10 and a virtual concatenation frame processor 20.

The extended header terminator 10 analyzes a header of a multiplexed packet 71 (generic name for packet 71a_1 or the like described later) received from a channel terminator 200 of a physical interface connected to a packet multiplexing network (not shown), and determines a packet output channel.

Then, the extended header terminator 10 adds a port identifier or the like indicative of an output channel as an extended tag (hereinafter, referred to as an in-device tag) based on the determination result, whereby a packet 70 (generic name for packet 70a_1 or the like described later) is logically distributed.

The virtual concatenation frame processor 20 receives the packet 70, maps the packet 71 to a virtual concatenation channel (including a usual channel which is not concatenated) based on the added extended header, and outputs it to a time division multiplexing switch 300, for example, on a time division multiplexing channel network side.

Conversely, the frame processor 20 de-maps the packet 71 included in the time division multiplexing channels from the time division multiplexing switch 300, and provides to the extended header terminator 10 the packet 70 that is the packet 71 having added thereto the extended header. The extended header terminator 10 processes the packet 71 based on the extended header, and transmits the packet 71 to the packet multiplexing network through the channel terminator 200.

Hereinafter, the embodiments (1) and (2) of the interface device 100 will be described in more detail.

### EMBODIMENT (1)

### Transmission of Unicast Packet and Broadcast Packet

The embodiment (1) in case where the interface device 100 transmits a unicast packet and a broadcast packet will now be described.

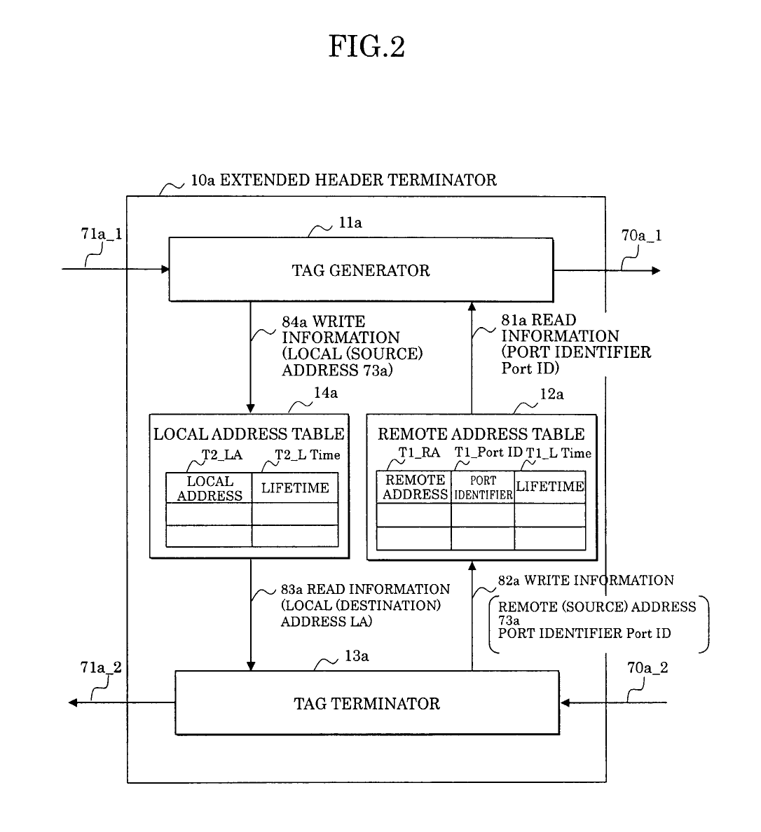

FIG. 2 shows the embodiment (1) of the extended header terminator 10a shown in FIG. 1. This extended header terminator 10a is composed of a tag generator 11a, a tag terminator 13a, a remote address table 12a, and a local address table 14a.

The remote address table 12a is composed of a remote address field T1_RA, a port identifier field T1_PortID, and a lifetime field T1_LTime. In each field, there are registered a “remote address RA”, a “port identifier PortID” of the time division multiplexing channel corresponding to the “remote address RA”, and a “lifetime LTime” of these data.

The local address table 14a is composed of a local address field T2_LA and a lifetime field T2_LTime. In each field, the “local address LA” and the “lifetime LTime” of the data are registered.

The data registered in the remote address table 12a and the local address table 14a are deleted after the “lifetime LTime” has elapsed after the registration. In this manner, unnecessary data registered in the tables 12a and 14a can be deleted.

The tag generator 11a registers or updates, with write information 84a, a source address (local address) of the packet 71a_1 received from the channel terminator 200 (see FIG. 1) in the local address table 14a.

It is to be noted that in the local address table 14a, it is possible to preliminarily register an address of a predetermined host on the packet multiplexing network side without the reception of the packet 71a_1 being triggered.

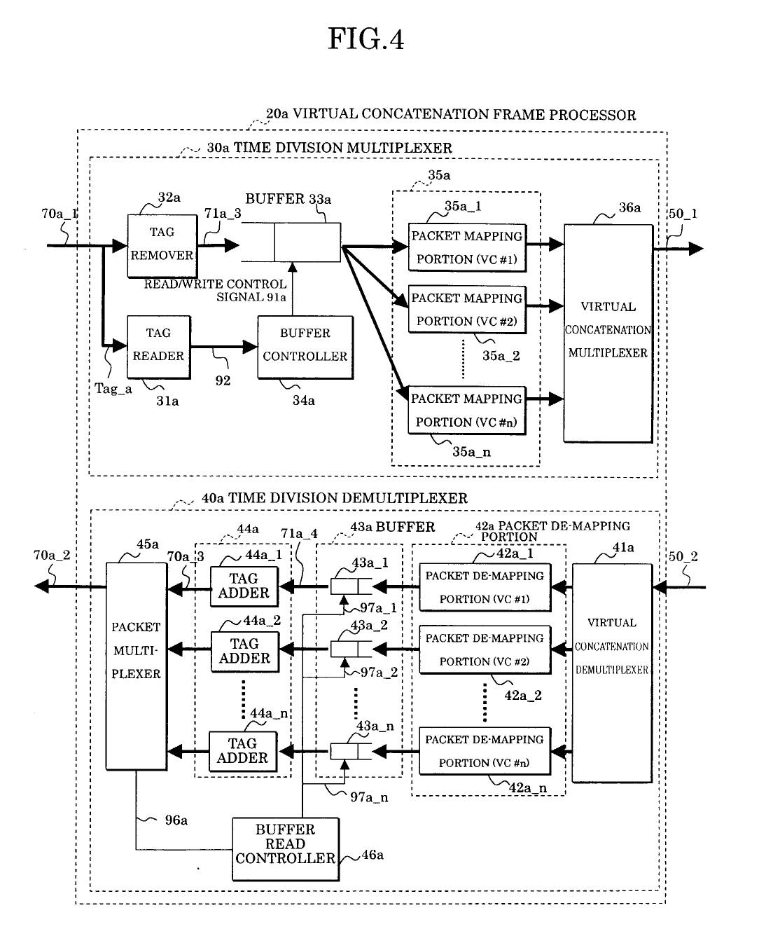

In addition, the tag generator 11a transmits to the virtual concatenation frame processor 20a (see FIG. 4) the packet 70a_1 that is the packet 71a_1 having added thereto a “port identifier PortID” and a “broadcast identifier BID” (hereinafter, occasionally these two identifiers generally referred to as in-device tag Tag_a). That is, the tag generator 11a refers to the remote address table 12a, reads the “port identifier PortID” corresponding to the destination address (remote address) of the packet 71a_1 with read information 81a, and adds the “port identifier PortID” to the packet 71a_1.

It is to be noted that when the destination address of the packet 71a_1 is not registered in the remote address table 12a, the tag generator 11a discards the packet 71a_1.

Furthermore, the tag generator 11a adds to the packet 70a_1 the “broadcast identifier BID” indicative of whether or not the packet 71a_1 is a broadcast packet or a unicast packet.

The tag terminator 13a receives from the frame processor 20a a packet 70a_2 to which the “port identifier PortID” and the “broadcast identifier BID” are added. Then, the tag terminator 13a associates the “port identifier PortID” with the source address (remote address) of the packet 70a_2, and registers or updates them in the remote address table 12a with write information 82a.

It is to be noted that in the remote address table 12a, an address (remote address) of a predetermined host on the time division multiplexing channel network side and the “port identifier PortID” corresponding to the remote address can be preliminarily registered instead of registering or updating the “port identifier PortID” included in the received packet 70a_2.

Furthermore, the tag terminator 13a retrieves the local address table 14a with read information 83a. In case where the destination address (local address) of the packet 70a_2 is registered in the local address table 14a, the tag terminator 13a transmits to the channel terminator 200 a packet 71a_2 that is the packet 70a_2 having deleted therefrom the in-device tag Tag_a. If the address is not registered, the packet 70a_2 is discarded.

It is to be noted that in case where the packet 70a_2 is a broadcast packet, the tag terminator 13a may transmit to the channel terminator 200 the packet 71a_2 that is the packet 70a_2 having deleted therefrom the in device tag Tag_a irrespective of whether or not the destination address (local address) of the packet 70a_2 is registered in the local address table 14a.

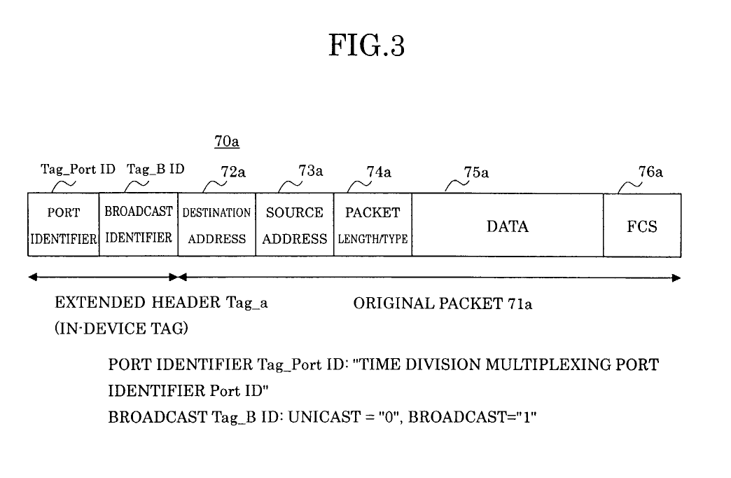

FIG. 3 shows an arrangement of the packet 70a_1 transmitted by the tag generator 11a shown in FIG. 2 and the packet 70a_2 received by the tag terminator 13a in the embodiment (1). It is to be noted that the packets 70a_1 and 70a_2 are identical to each other in configuration. Hereinafter, the packets 70a_1 and 70a_2 are occasionally and generally referred to as a packet 70a.

The packet 70a is composed of an original packet 71a corresponding to the packet multiplexing network side and the in-device tag Tag_a.

In this example, the original packet 71a is defined as an Ethernet packet, and is composed of a destination address field 72a, a source address field 73a, a packet length/type field 74a, a data field 75a, and an FCS (Frame Check Sequence) field 76a.

The extended header Tag_a is composed of a port identifier field Tag_PortID and a broadcast identifier field Tag_BID.

The “port identifier PortID” of the port corresponding to the destination address (remote address) 72a of the packet 70a_1 (see FIG. 2) is set in the port identifier field Tag_PortID of the packet 71a_1. The “port identifier PortID” of the port corresponding to the source address (remote address) 73a of the packet 70a_2 (see FIG. 2) is set.

Additionally, in case where the packet 71a is a unicast, “broadcast identifier BID”=“0” is set in the broadcast identifier field Tag_BID. When the packet is broadcast, “broadcast identifier BID”=“1” is set.

FIG. 4 shows an arrangement of the virtual concatenation frame processor 20a (see FIG. 1) in the embodiment (1). This frame processor 20a is composed of a time division multiplexer 30a for mapping the packet 70a_1 (see FIG. 3) received from the tag generator 11a (see FIG. 2) on the virtual concatenation channel and for transmitting the packet to the time division multiplexing channel network side and a time division demultiplexer 40a for assigning to the tag terminator 13a (see FIG. 2) the packet 70a_2 in which the in-device tag Tag_a is added to the packet de-mapped from a time division multiplexing channel 50_2 from the time division multiplexing channel network side.

The time division multiplexer 30a includes a tag reader 31a for reading the in-device tag Tag_a of the packet 70a_1, a tag remover 32a for outputting a packet 71a_3 (the same packet as the original packet 71a shown in FIG. 3) that is the packet 70a_1 having deleted therefrom the in-device tag Tag_a, and a buffer 33a for temporarily storing the packet 71a_3.

In addition, the time division multiplexer 30a includes a buffer controller 34a for instructing the buffer 33a of a write timing and a read timing of the packet 71a_3 with a read/write control signal 91a generated based on tag information 92 (“port identifier PortID” and “broadcast identifier BID”) included in the in-device tag Tag_a from the tag reader 31a and a packet mapping potion 35a_1 for mapping the packet 71a_3 received from the buffer 33a on a predetermined virtual concatenation channel (including a usual channel which is not a virtual concatenation channel) based on the read timing of the buffer controller 34a.

This packet mapping portion 35a is composed of logical packet mapping portions 35a_1-35a_n corresponding to the virtual concatenation channels of a predetermined bandwidth.

That is, when the “broadcast identifier BID”=“0”, the buffer controller 34a provides the packet 71a_3, for example, to the logical packet mapping portion 35a_1 corresponding to the “port identifier PortID”=“1”.

In addition, when the “broadcast identifier BID”=“1”, the buffer controller 34a provides the packet 71a_3 to all of the logical packet mapping portions 35a_1-35a_n. That is, the packet 71a_3 is broadcast.

In addition, the time division multiplexer 30a includes a virtual concatenation multiplexer 36a for multiplexing the virtual concatenation channel from the packet mapping portion 35a into a time division multiplexing channel 50_1 on the time division multiplexing channel network side.

The time division demultiplexer 40a includes a virtual concatenation demultiplexer 41a for demultiplexing a time division multiplexing channel 50_2 on the time division multiplexing channel network side into a virtual concatenation frame (including a usual frame which is not the virtual concatenation frame), a packet de-mapping portion 42a (42a_1-42a_n) for de-mapping a packet 71a_4 from the demultiplexed virtual concatenation frame, and a buffer 43a (43a_1-43a_n) for temporarily storing the de-mapped packet 71a_4.

Furthermore, the time division demultiplexer 40a includes a buffer read controller 46a for providing to the buffers 43a_1-43a_n read timing signals 97a_1-97a_n of the packets respectively stored in the buffers 43a_1-43a_n, a tag adder 44a (44a_1-44a_n) for adding the in-device tag Tag_a (=“port identifier PortID” and “broadcast identifier BID”) corresponding to the packets read from the buffers 43a_1-43_n, and a packet multiplexer 45a for packet multiplexing, the packet 70a_3 to which the in-device tag Tag_a is added, for outputting the packet, and for providing to the buffer read controller 46a a read enable signal 96a for enabling the packet read from the buffer 43a.

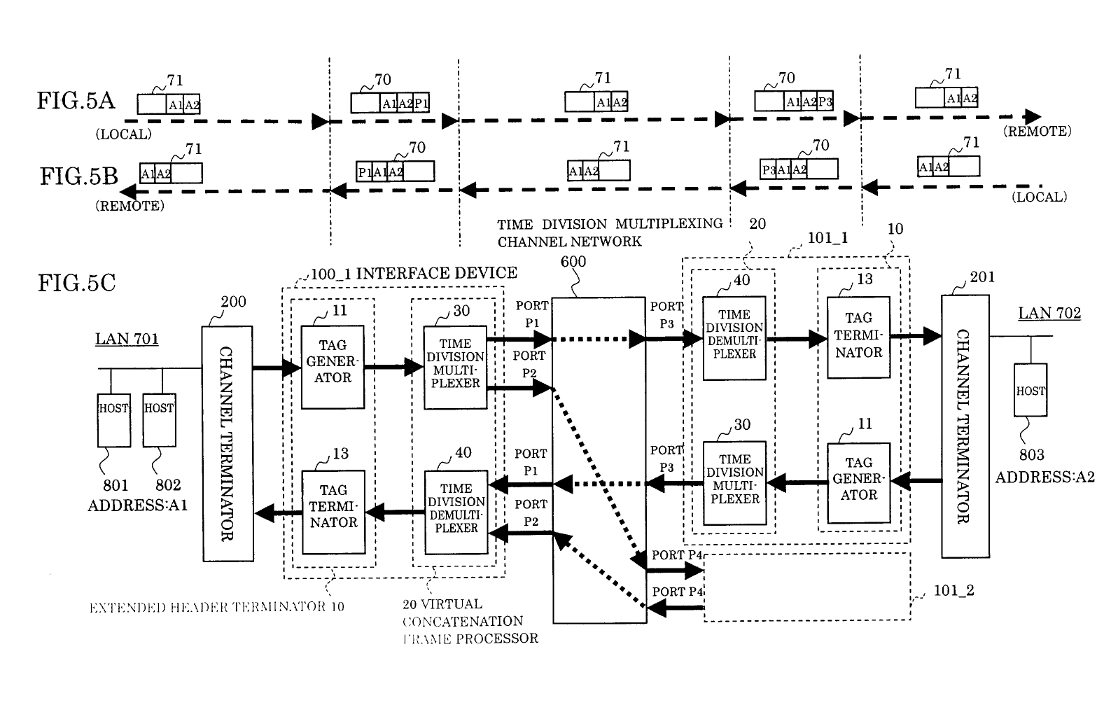

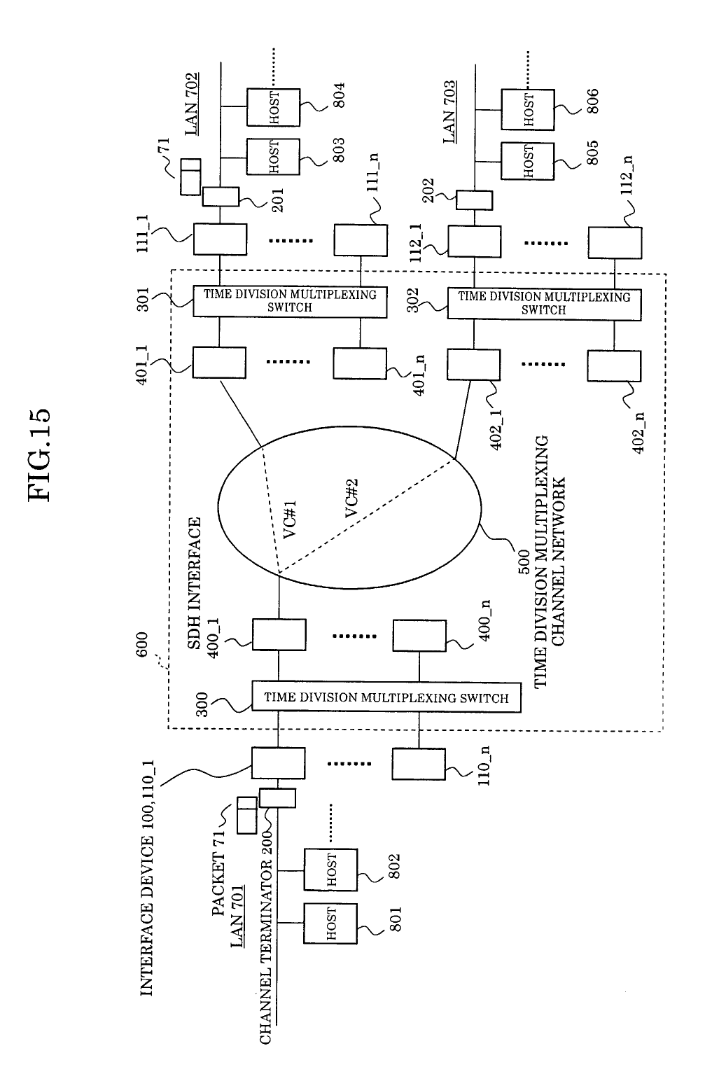

FIG. 5C shows a WAN network to which the interface device according to the present invention is applied. This network shows in more detail the interface device according to the present invention in particular, of the WAN networks shown in FIG. 15, and some other parts are omitted.

That is, in the network, there are sequentially connected the LAN network 701, the channel terminator 200, the interface device 100_1 according to the present invention, a time division multiplexing channel network 600, the interface device 101_1 having the same configuration as the above-mentioned interface device 100, the channel terminator 201, and the LAN network 702.

The time division multiplexing channel network 600 includes the time division multiplexing switches 300-302, the SDH interfaces 400_1-400_n, 401_1-401_n, and 402_1-402_n, and the time division multiplexing channel network 500 in the WAN network shown in FIG. 15.

The host 801 (address A1) and the host 802 are connected to the LAN network 701. The host 803 (address A2) is connected to the LAN network 702.

In addition, the time division demultiplexer 30 of the interface device 100_1 is connected to the time division multiplexing channel network 600 at ports P1 and P2. The time division demultiplexer 40 of the interface device 100_1 is connected to the time division multiplexing channel network 600 at ports P1 and P2. The time division demultiplexer 30 of the interface device 101_1 is connected to the time division multiplexing channel network 600 at a port P3. The time division demultiplexer 40 of the interface device 101_1 is connected to the time division multiplexing channel network 600 at a port P3.

FIG. 5A shows positions where the in-device tags (only a port identifier is indicated and the other identifier is omitted) Tag_a are added to or deleted from the packet 71 (destination address A2 and source address A1) transmitted from the host 801 to the host 803.

That is, in the interface device 100_1, a port identifier P1 is added to the packet 71, and is packet-processed based on the port identifier P1, so that the port identifier P1 is deleted. In the time division multiplexing channel network 600, the packet 71 is mapped on the time division multiplexing channel to be transmitted. In the interface device 101_1, a port identifier P3 is added to the packet 71, and is packet-processed based on the port identifier P3, so that the port identifier P3 is deleted.

It is to be noted that the (local) and (remote) in FIG. 5A indicate the local side and the remote side when attention is paid to the interface device 100_1.

FIG. 5B shows positions where the port identifier is added to or deleted from the packet 71 (destination address A1 and source address A2) transmitted from the host 803 to the host 801 conversely. This position is the same as that shown in FIG. 5A.

In addition, the (local) and (remote) in FIG. 5B indicate the local side and the remote side when attention is paid to the interface device 101_1.

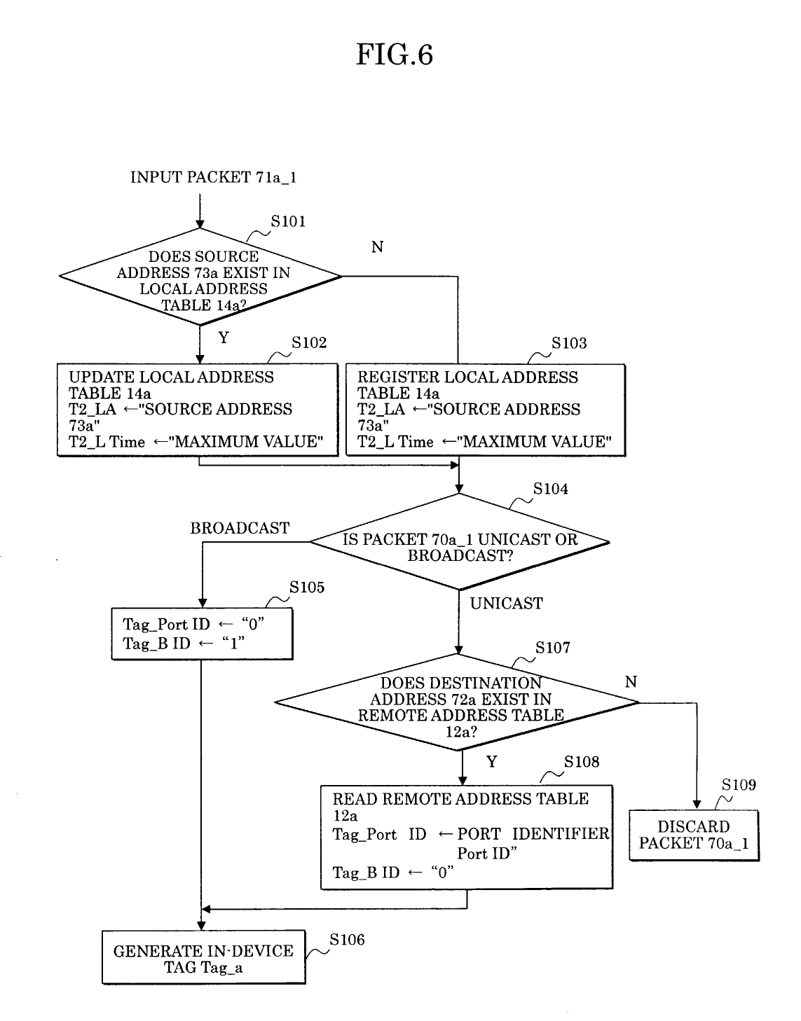

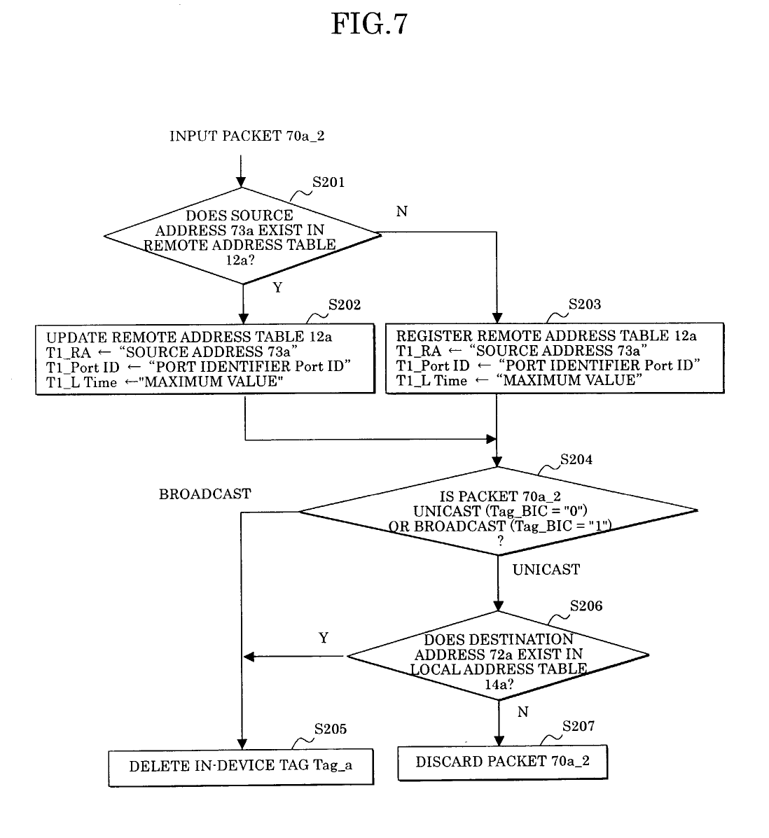

FIGS. 6 and 7 respectively show examples of operation procedures for the tag generator 11a and the tag terminator 13a shown in FIG. 2. Hereinafter, by referring to FIGS. 6 and 7, an operation procedure for the interface device 100 (reference numeral 101 in FIGS. 5A-5C) of the present invention will be described by taking as an example the case where packets are exchanged between the hosts 801 and 803 in FIGS. 5A-5C.

Firstly, the operation procedure will be described in case where a broadcast packet 71a_1 (destination address=“0”) is transmitted in accordance with e.g. an ARP (Address Resolution Protocol) protocol.

Steps S101 and S102 in FIG. 6: The tag generator 11a checks whether or not the “source address 73a” in the packet 71a_1 (the same as the original packet 71a in FIG. 3) received from the channel terminator 200 has already been registered in the local address table 14a.

In case where the address has been registered, the local address field T2_LA and the lifetime field T1_LTime in the local address table 14a are respectively updated by the tag generator 11a with the “source address 73a (see FIG. 3)” and a predetermined “maximum value” of the packet 71a_1.

Step S103: If the address has not been registered, the tag generator 11a registers in the local address table 14a the data composed of the “source address 73a” of the local address field T2_LA=packet 71a_1 and the lifetime field T2_LTime=a predetermined “maximum value”.

Steps S104-S106: The tag generator 11a detects that the “destination address 72a” of the packet 71a_1=“0”, and recognizes that the packet 71a_1 is a broadcast packet.

The tag generator 11a generates the in-device tag Tag_a composed of the port identifier field Tag_PortID=“0 (indicating all the ports)” and the broadcast identifier field Tag_BID=“1 (indicating a broadcast packet)”. The tag generator 11a outputs the packet 70a_1 that is the packet 71a_1 having added thereto the in-device tag Tag_a.

In FIG. 4, at the time division multiplexer 30a of the virtual concatenation frame processor 20a, the tag reader 31a reads the port identifier PortID=“0” from the in-device tag Tag_a of the received packet 70a_1. Then, the tag reader 31a notifies to the packet controller 34a that the packet 70a_1 is a broadcast packet with tag information 92.

On the other hand, the tag remover 32a generates the packet 71a_3 that is the packet 70a_1 having deleted therefrom the in-device tag Tag_a. Then, the buffer 33a writes the packet 71a_3 with a write control signal 91a from the buffer controller 34a.

The packet 71a_3 stored in the buffer 33a is broadcast to all of the logical packet mapping portions 35a_1-35a_n with a read control signal 91a from the buffer controller 34a. Then, the packet is mapped on the virtual concatenation channels.

At this time, the packet mapping portions 35a_1-35a_n are set in a bandwidth corresponding to the packet 71a_3.

Each channel is multiplexed into the high-speed channel 50_1 at the virtual concatenation multiplexer 36b to be outputted to the time division multiplexing channel network 600.

The high-speed channel 50_1 (port P1) is provided as a high-speed channel 50_2 (port P3) to the interface device 101_1 (see FIGS. 5A-5C).

In the interface device 101_1, the virtual concatenation demultiplexer 41a (see FIG. 4) of the time division demultiplexer 40a time-division-demultiplexes the virtual concatenation channel from the high-speed channel 50_2. The packet de-mapping portion 42a_3 de-maps the packet 71a_4 of the broadcast from the demultiplexed channel. The buffer 43a_1 stores this packet 71a_4.

The tag adder 44a provides to the tag terminator 13a (see FIG. 2) the packet 70a_2 (see FIG. 3) that is the packet 71a_4 having added thereto the in-device tag Tag_a set to the “port identifier PortID”=“3” corresponding to the packet de-mapping portion 42a_3 and the “broadcast identifier BID”=“1” indicative of a broadcast.

The tag terminator 13a processes the packet 70a_2 in accordance with an example of an operation procedure in FIG. 6.

Steps S201 and S203: The tag terminator 13a checks whether or not the “source address 73a” of the packet 70a_2 is registered in the remote address table 12a. If the address is not registered, the “source address 73a”, the “port identifier PortID”=“3”, and the “maximum value” are respectively registered in the remote address field T1_RA, the port identifier field T1_PortID, and the lifetime field T1_LTime.

Steps S204 and S205: Furthermore, since the “broadcast identifier BID”=“1” in the packet 70a_2, the tag terminator 13a transmits the packet 71a_1 that is the packet 70a_2 having deleted therefrom the in-device tag Tag_a to the host 803 of the packet multiplexing network 703 through the channel terminator 200 (see FIG. 1).

An operation in case where the unicast packet 71a_1 is transmitted to the host 801 will be described.

The packet 71a_1 is transmitted to the tag generator 11a of the interface device 101_1 through the LAN network 702 and the channel terminator 201 (see FIGS. 2 and 6).

The tag generator 11a processes the packet 71a_1 in accordance with the operation procedure shown in FIG. 6.

Steps S101, S102, and S103: The tag generator 11a registers or updates the “source address 73a” and the “maximum value” of the packet 71a_1 respectively in the local address field T2_LA and the lifetime field T2_LTime of the local address table 14a.

Steps S104, S107, and S108: Since the “destination address 72a” of the unicast packet 70a_1 is registered in the remote address table 12a (registered at the above-mentioned step S203 of the tag terminator 13a), the tag generator 11a reads the “port identifier PortID”=“3” corresponding to the “destination address 72a” (=remote address) from this table 12a.

Then, the tag generator 11a generates the in-device tag Tag_a in which “0” indicative of the read “port identifier PortID”=“3” and the unicast packet respectively are set in the port identifier field Tag_PortID and the broadcast identifier field Tag_BID, and transmits the packet 70a_1 that is the packet 71a_1 having added thereto the in-device tag Tag_a to the time division multiplexer 30a of the frame processor 20a.

This time division multiplexer 30a (see FIG. 4) maps on the channel based on the in-device tag Tag_a of the packet 70a_1, the packet 71a_1 that is the packet 70a_1 having deleted therefrom the in-device tag Tag_a at the packet mapping portion 35a_3 corresponding to e.g. the “port identifier PortID”=“3”, and transmits to time division multiplexing network 600 the high-speed channel 50_1 in which the channel is multiplexed in the virtual concatenation multiplexer 36a.

At the interface device 100_1, the time division demultiplexer 40a (see FIG. 4) time-division-demultiplexes the received high-speed channel 50_2, and, for example, de-maps the packet 71a_4 from the channel at the packet de-mapping portion 42a_1.

Furthermore, the time division demultiplexer 40a adds to the packet 71a_4, the in-device tag Tag_a in which the “port identifier PortID”=“1” corresponding to the packet de-mapping portion 42a_1 and “0” indicating that the packet 71a_1 is a unicast packet are respectively set to the port identifier field Tag_PortID and the broadcast identifier field Tag_BID. Then, they are multiplexed into a packet de-mapped from the other channels, and the packet 70a_2 is transmitted to the tag terminator 13a (see FIG. 2).

The tag terminator 13a treats the packet 70a_2 in accordance with the operation procedure shown in FIG. 7.

Steps S201 and S203: The tag terminator 13a refers to the in-device tag Tag_a of the unicast packet 70a_2, and registers the “source address 73a” of the packet 70a_2, the “port identifier PortID”=“1” corresponding to the packet de-mapping portion 42a_2, and a predetermined “maximum value” respectively in the remote address field T1_RA, the port identifier field T1_PortID, and the lifetime field T1_LTime of the remote address table 12a.

Steps S204, S206, and S205: Furthermore, since the packet 70a_2 is a unicast packet, the tag terminator 13a retrieves whether or not the destination address 72a of the packet 70a_1 is registered in the local address table 14a. This address is already registered (registered at step S103 when the above-mentioned broadcast packet is transmitted). Therefore, the packet 71a_2 that is the packet 70a_2 having deleted therefrom the in-device tag Tag_a is transmitted to the host 801 through the channel terminator 200 and LAN network 701.

Steps S206 and S207: It is to be noted that in case where the “destination address 72a (address (local address) of the host 801)” is not registered in the local address table 14a, the packet 71a_1 is discarded.

### EMBODIMENT (2)

### Transmission of Unicast Packet and Multicast Packet

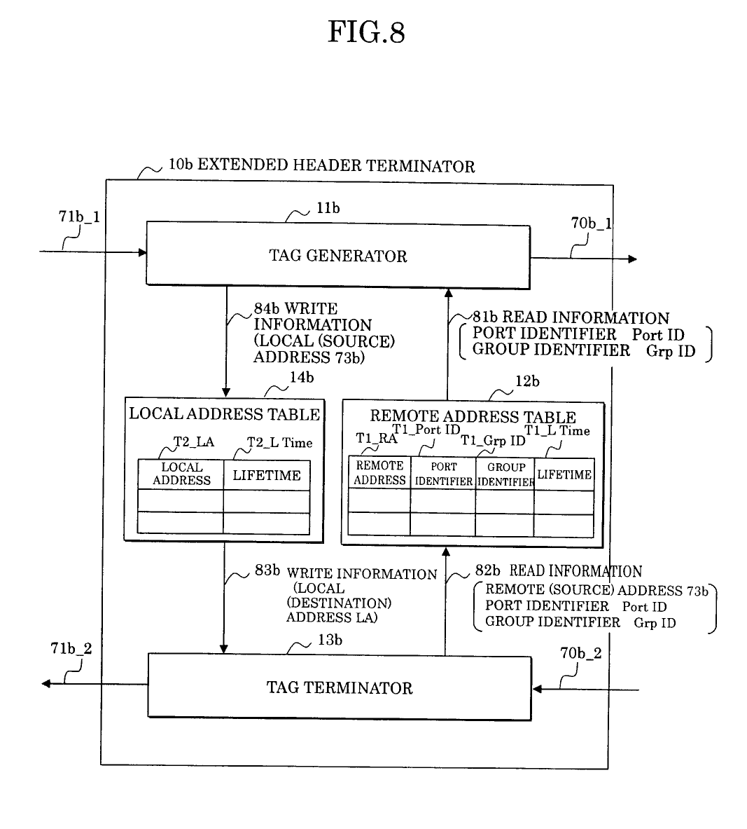

FIG. 8 shows an arrangement of an extended header terminator 10b in the embodiment (2) of the interface device 100 according to the present invention. This extended header terminator 10b is different from the extended header terminator 10a (see FIG. 2) of the embodiment (1) in that a group identifier field T1_GrpID for setting to the remote address table 12b a “group identifier GrpID” corresponding to the “remote address RA” is further provided.

An operation of a tag generator 11b is different from that of the tag generator 11a in the embodiment (1) (see FIG. 8) in that the “group identifier GrpID” corresponding to the destination address (remote address) of the packet 71b_1 is read from the remote address table 12b, and the “group identifier GrpID” is set in the group identifier field Tag_GrpID added to an in-device tag Tag_b.

In addition, an operation of a tag terminator 13b is different from that of the tag terminator 13a in the embodiment (1) in that the “group identifier GrpID” included in the packet 70b_2 is registered in the remote address table 12b in association with the source address of the packet 70b_2.

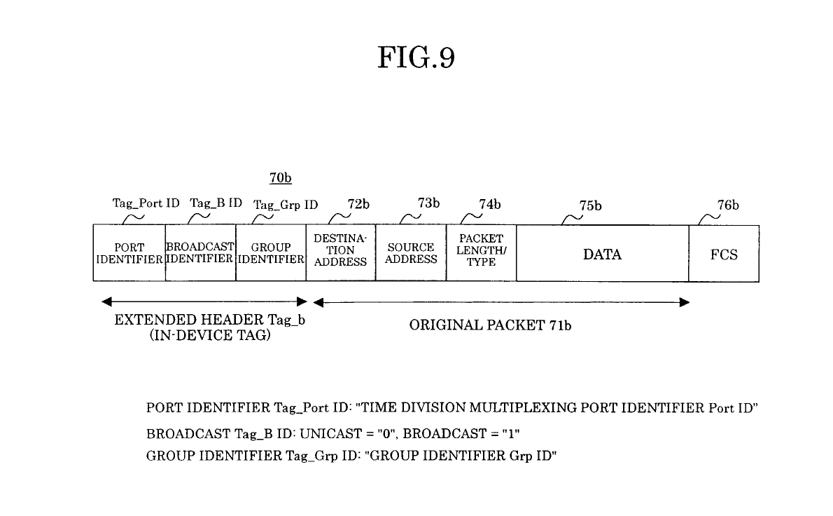

FIG. 9 shows an arrangement of the packet 70b_1 outputted by the tag generator 11b and packet 70b_2 received by the tag terminator 13b. Like the packet 70a shown in FIG. 3, the configurations of the packets 70b_1 and 70_2 are identical. Hereinafter, the packets 70b_1 and 70b_2 are occasionally and generally referred to as a packet 70b.

The packet 70b is different from the packet 70a in that the packet 70b includes the group identifier field Tag_GrpID in the in-device tag Tag_b. In case where the packet 71b is a multicast packet, the group identifier GrpID” corresponding to this packet 71b is set in this group identifier field Tag_GrpID. The “broadcast identifier BID”=“1” is set in the broadcast identifier field Tag_BID.

It is to be noted that the original packet 71b is an Ethernet packet similar to the original packet 71a of the packet 70a.

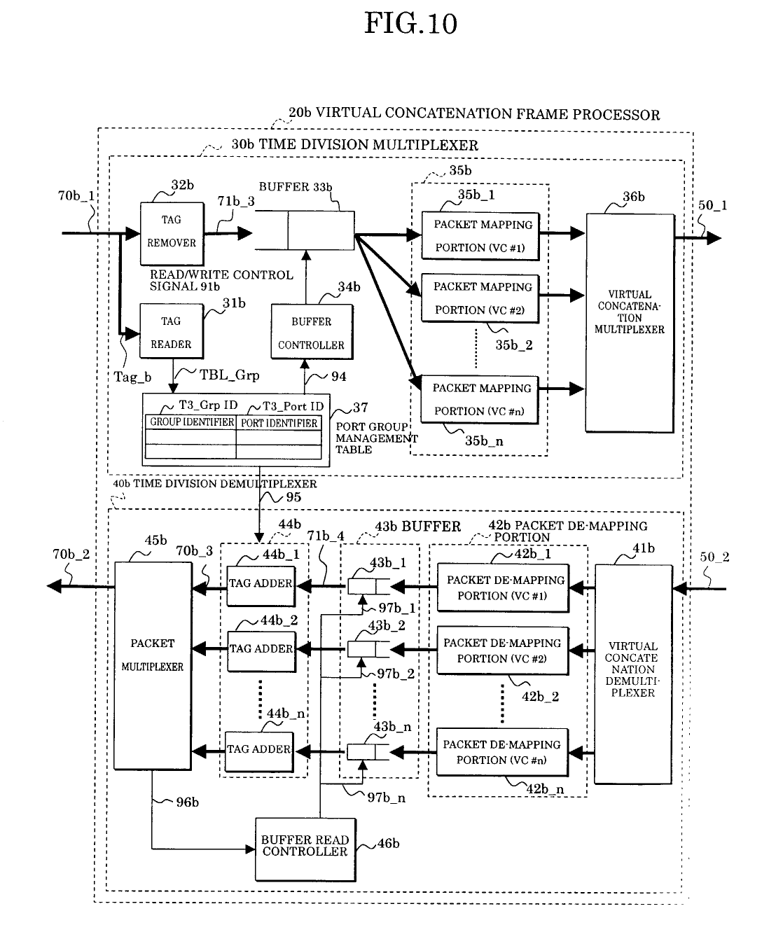

FIG. 10 shows an arrangement of a virtual concatenation frame processor 20b in the embodiment (2). This frame processor 20b is composed of the time division multiplexer 30b and time division demultiplexer 40b in the same way as in the virtual concatenation frame processor 20a (see FIG. 4) in the embodiment (1).

The time division multiplexer 30b is different from the time division multiplexer 30a in the embodiment (1) in that a port group management table 37 is added. The “port identifier PortTD” and the “group identifier GrpID” associated with each other are preset in this port group management table 37.

In addition, it is also different from the time division multiplexer 30a in that the tag reader 31b provides a signal TBL_Grp to the port group management table 37, and the management table 37 provides a signal 94 to a buffer controller 34b.

An operation of the time division multiplexer 30b is different from that of the time division multiplexer 30a in the embodiment (1) in that the signal TBL_Grp is provided to the port group management table 37 based on the in-device tag Tag_b read by the tag reader 31b from the packet 70b_1, and based on this signal TBL_Grp, the management table 37 provides to the buffer controller 34b the port identifier corresponding to the unicasting, the multicasting, or the broadcasting.

An arrangement of the time division demultiplexer 40b is different from that of the time division demultiplexer 40a in the embodiment (1) in that a tag adder 44b receives a signal 95 from the management table 37.

The time division demultiplexer 40b further retrieves from the port group management table 37 the “group identifier GrpID” corresponding to the “port identifier PortID” corresponding to the packet de-mapping portions 42b_1-42b_n in which the packet 71b is de-mapped, and sets the “group identifier GrpID” in the group identifier field Tag_GrpID of the in-device tag Tag_b.

That is, the in-device tag Tag_b of the packet 70b_2 outputted from the time division demultiplexer 40b is composed of the port identifier field Tag_PortID, the broadcast identifier field Tag_BID, and the group identifier field Tag_Grp, as shown in FIG. 9.

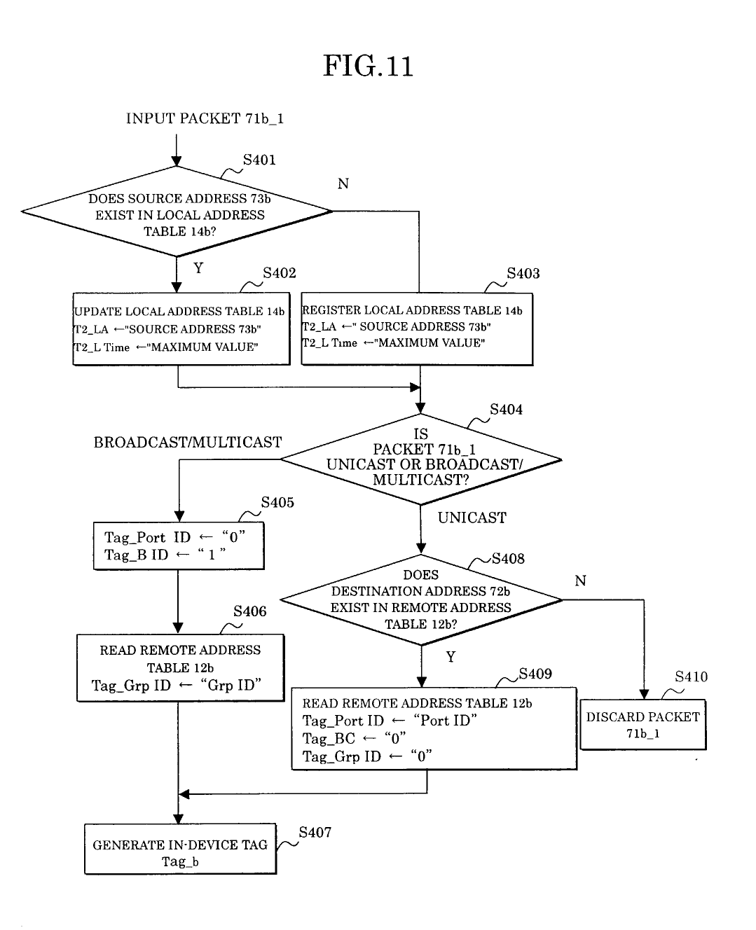

FIGS. 11-14 show examples of operation procedures for the tag generator 11b, the time division multiplexer 30b, the time division demultiplexer 40b, and the tag terminator 13b in the embodiment (2).

The procedure for transmitting the multicast packet 71b_1 from the host 801 to the host 803 in the WAN network shown in FIGS. 5A-5C will now be described.

The packet 71b_1 is transmitted to the interface device 100_1 through the LAN network 701 and the channel terminator 200.

FIG. 11 shows an operation procedure in which the tag generator 11b shown in FIG. 8 processes the packet 71b_1 in the interface device 100_1.

Steps S401-S403: The tag generator 11b registers or updates the “source address” of the packet 71b_1 in the local address table 14b as in the steps S101-S103 shown in FIG. 6.

Steps S404-S407: Since the packet 71b_1 is a multicast packet, the tag generator 11b adds the in-device tag Tag_b (see FIG. 9) to the packet 71b_1. Then, the port identifier field Tag_PortID=“0” and the broadcast identifier field Tag_BID=“1” are defined.

Furthermore, the tag generator 11b refers to the remote address table 12b, reads the “group identifier GrdID”=e.g. “1” corresponding to the “destination address 72b” of the packet 71b_1, and defines the group identifier field Tag_GrpID=“1” in the in-device tag Tag_b.

The tag generator 11b transmits to the time division multiplexer 30b (see FIG. 10) the packet 70b_1 that is the packet 71b_1 having added thereto the in-device tag Tag_b.

It is to be noted that, at this time, the “group identifier GrpID” corresponding to the remote address (destination address) RA is supposed to have already been registered in the remote address table 12b.

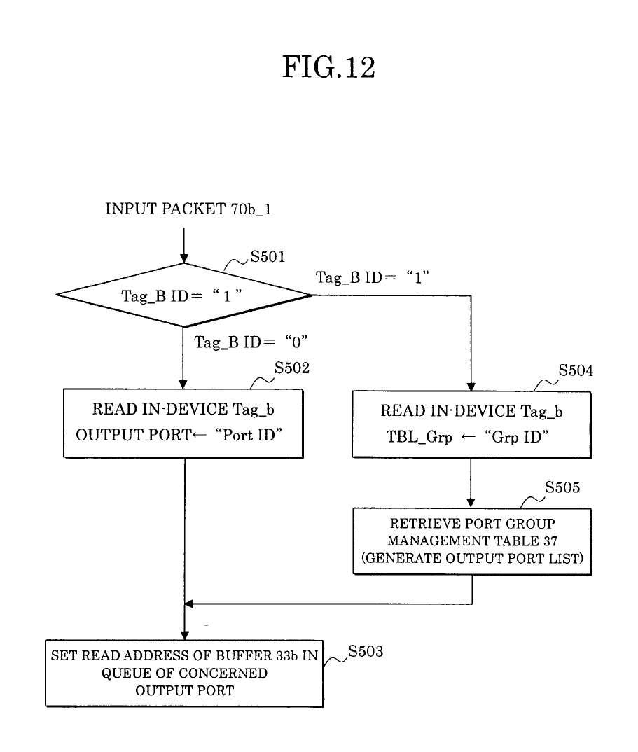

FIG. 12 shows an operation procedure in which the time division multiplexer 30b shown in FIG. 10 processes the received packet 70b_1. It is to be noted that the “port identifier PortID” corresponding to the “group identifier GrpID” is preset in the port group management table 37 of the time division multiplexer 30b. In addition, the output port (virtual concatenation channel (frame)) corresponding to the “port identifier PortID” is set in a frame of a bandwidth corresponding to that of the packet 70b_1.

Steps S501, S504, and S505: The tag reader 31b of the time division multiplexer 30b reads the in-device tag Tag_b of the packet 70b_1. Since the broadcast identifier field Tag_BID=“1”, “3” set in the group identifier field Tag_GrpID is provided to the port group management table 37 with the signal TBL_Grp.

Step S503: The buffer controller 34b receives with a signal 94 the output port identifiers (a plurality of port identifiers corresponding to multicast) corresponding to the signal TBL_Grp=“3” from the management table 37, prepares an output port list (not shown), and sets a read address of the buffer 33b in a queue (not shown) of the output port registered in the list.

The buffer 33b receives from the tag remover 32b a packet 71b_3 (similar to the packet 71b of FIG. 9; hereinafter, a reference numeral 71b is used) that is the packet 70b_1 having deleted therefrom the in-device tag Tag_b, and stores the packet.

The buffer controller 34b provides to the buffer 33b a read control signal 91b for providing the packet 70b to e.g. the packet mapping portions 35b_1, 35b_3, . . . corresponding to the “group identifier GrpID”=3” based on the read address set in the queue.

In this manner, the packet 70b is multicast to the packet mapping portions 35b_1, 35b_3, . . . corresponding to the bandwidth of this packet 70b.

Hereinafter, the operation in which the packet 71b is mapped on the virtual concatenation frame at the packet mapping portion 35b, and this frame is multiplexed into the time division multiplexing channel 50_1 at the virtual concatenation multiplexer 36b is the same as that of the embodiment (1).

The packet 71b (time division multiplexing channel 50_1) is transmitted to the interface device 101_1 through the time division multiplexing channel network 600 (see FIGS. 5A-5C).

In the interface device 101_1, as in the embodiment (1), the virtual concatenation demultiplexer 41b and the packet de-mapping portion 42b of the time division demultiplexer 40b de-map the packet 71b from the received time division multiplexing channel 50_2 to be provided to the buffer 43b (see FIG. 10).

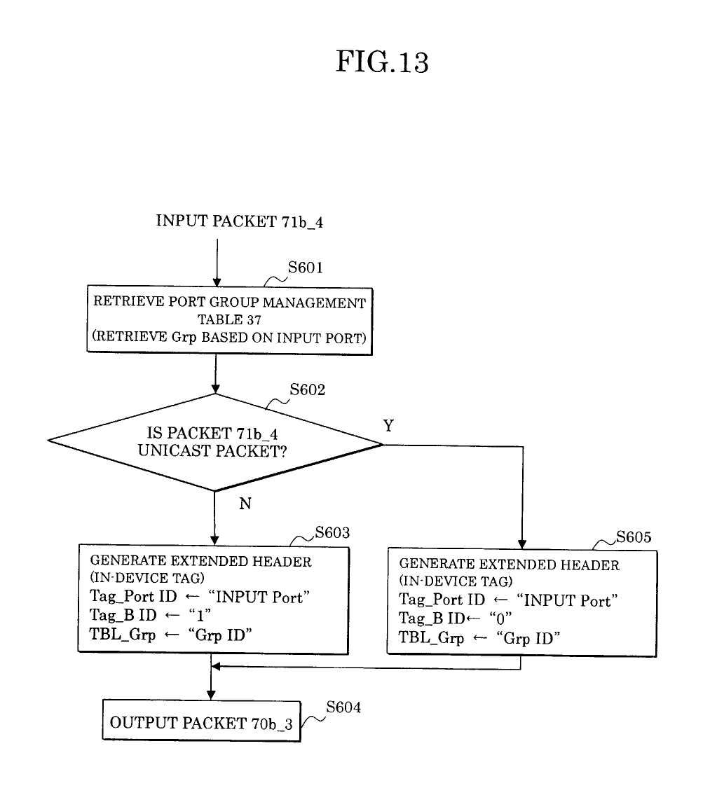

FIG. 13 shows an operation procedure in which the time division demultiplexer 40b processes the packet 71b (indicated by a reference numeral 71b_4 in FIG. 13).

It is to be noted that also in the port group management table 37 of the interface device 101_1, as in the port group management table 37 of the interface device 100_1, the “group identifier GrpID” and the “port identifier PortID” are preset in association with each other.

That is, the “group identifier GrpID” and the “port identifier PortID” to be multicast are associated with each other and registered. At this time, if the “group identifier GrpID” and all of the “port identifiers PortID” are associated with each other and registered, it means that the broadcast is set.

Steps S601-S604: The buffer read controller 46b receives a read enable signal 96b from the packet multiplexer 45b, provides e.g. a read timing signal 97b_1 to a buffer 43b_1, and reads the packet 71b_4 to be provided to the read tag adder 44b_1.

Since the packet 71b is a multicast packet, the tag adder 44b reads the “group identifier GrpID=e.g. “3” corresponding to the “port identifier PortID”=e.g. “1” of the port which has transmitted the packet 71b from the port group management table 37.

Then, the tag adder 44b sets “1”, “1”, and “3” respectively in the port identifier field Tag_PortID, the broadcast identifier field Tag_BID, and the group identifier field Tag_GrpID of the in-device tag Tag_b. Furthermore, the tag adder 44b provides to the packet multiplexer 45b a packet 70b_3 (see FIG. 9) that is the packet 71b having added thereto the in-device tag Tag_b.

The packet multiplexer 45b multiplexes the packet 70b_3 and packets from the other tag adders 44b_2-44b_n to be provided as a packet 70b_4 to the tag terminator 13b (see FIG. 8).

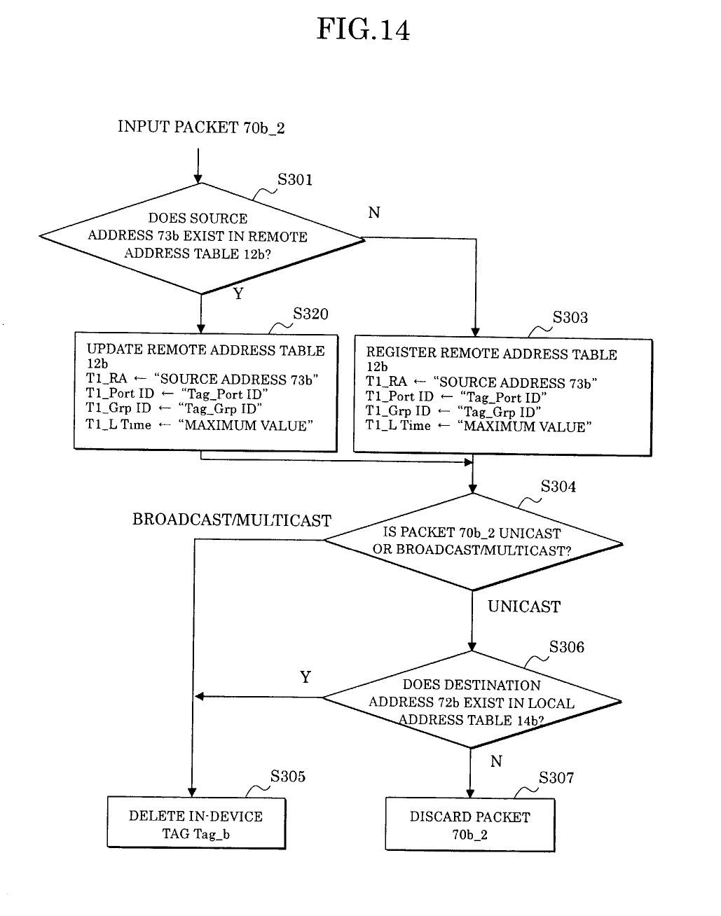

FIG. 14 shows an operation procedure in which the tag terminator 13b processes the packet 70b_4.

Steps S301, S302, and S303: In case where the “source address 73b” of the packet 70b_2 is registered or not registered in the remote address table 12b, the tag terminator 13b updates or registers data corresponding to the “source address 73b”.

That is, the tag terminator 13b sets the “source address 73b”, “1”, “3”, and the “maximum value” respectively in the remote address field T1_RA, the port identifier field T1_PortID, the group identifier field T1_GrpID, and the lifetime field LTime in the remote address table 12b.

This indicates that it has been autonomously registered in the remote address table 12b that the source host 801 of the “address 73b” belongs to the group “3” of the multicast.

Steps S304 and S305: Since the packet 70b_2 is a multicast packet, the tag terminator 13b transmits the packet 71b_2 that is the packet 70b_2 having deleted therefrom the in-device tag Tag_b.

This packet 71b_1 is transmitted to the host 803 through the channel terminator 201 and the LAN network 702 (see FIGS. 5A-5C). In this manner, the multicast packet 71 transmitted from the host 801 of the LAN network 701 is assumed to have been transmitted to the host 803 of the LAN network 702 which is one of the destinations in the bandwidth corresponding to that of the packet 71.

Conversely, in case where the multicast (or broadcast) packet 71b is transmitted from the host 803 to the host 801, the remote address table 12a is referred to at the tag generator 11a. Since it has been autonomously registered in this table 12a that the destination host 801 belongs to the group “3”, the group identifier field Tag_GrpID of the “group identifier GrpID”=“3” is added to the packet 71b.

Then, at the time division multiplexer 30b at the next stage, the port group management table 37 is referred to, and the packet 71b is transmitted to the port corresponding to the group “3”.

As described above, an interface device and a network system according to the present invention is arranged such that an address table associates a destination address and a port identifier of time division multiplexing channels for transmitting a received packet with each other to be stored, a tag generator adds the port identifier to the packet based on this address table, and a time division multiplexer maps the packet from the tag generator to the time division multiplexing channel corresponding to the port identifier. Therefore, it becomes possible to perform a logical switching of the received packet, thereby enabling the interface device and the network system in which the number of channels is variable to be constructed with an easily realizable circuit construction.

In addition, by associating the port identifier with virtual concatenation channels in which a plurality of time division multiplexing channels are concatenated, the interface device enabling time division frame processing in which a bandwidth is variable and the number of channels is variable can be constructed.

In addition, when a packet received by the time division multiplexer is a broadcast packet, packets are transmitted to all of the time division multiplexing channels. Thus, it becomes possible to perform processing corresponding to the broadcast packet.

Furthermore, based on a port group management table where a group identifier and a port identifier are associated with each other, the received packets are transmitted to the time division multiplexing channels corresponding to all of the port identifiers designated by the group identifier, thereby enabling the multicasting.

That is, according to the interface device and the network system of the present invention, while circuit scale, power consumption, and mounting area are suppressed, it becomes possible to mutually connect a packet multiplexing network and a time division multiplexing channel network in a state of a variable bandwidth without reducing system throughput.

Also, since a physical port is not divided, higher channel bandwidth (high-speed channel) can be comparatively easily achieved in the same circuit construction.

What we claim is:

1. An interface device comprising:
an address table in which a destination address of a packet is associated with a port identifier uniquely indicative of a time division multiplexing channel which transmits the packet;
a tag generator for adding to a received packet a port identifier corresponding to a destination address of the packet based on the address table; and
a time division multiplexer for mapping the packet from the tag generator to a time division multiplexing channel corresponding to the port identifier added thereto.

2. The interface device as claimed in claim 1 wherein the port identifier corresponds to a concatenation channel over which a plurality of time division multiplexing channels are concatenated, and
the time division multiplexer maps the packet to a concatenation channel corresponding to the port identifier added to the packet.

3. The interface device as claimed in claim 1 wherein the tag generator adds a broadcast identifier to the packet when the packet is a broadcast packet, and
the time division multiplexer deletes the broadcast identifier from the packet, and then transmits the packet to the time division multiplexing channels corresponding to all ports.

4. The interface device as claimed in claim 1 wherein the time division multiplexer transmits the packet to all of the time division multiplexing channels when the received packet is a broadcast packet.

5. The interface device as claimed in claim 1 wherein the tag generator discards a packet whose address is not registered in the address table and is defined as a destination address.

6. The interface device as claimed in claim 1, further comprising:
a time division demultiplexer for adding a port identifier of a terminated time division multiplexing channel to a packet de-mapped from the time division multiplexing channel; and
a tag terminator for associating a transmission source address of the packet from the time division demultiplexer with the added port identifier to be registered or updated in the address table.

7. The interface device as claimed in claim 6, further comprising:
a time division demultiplexer for de-mapping a packet from a time division multiplexing channel terminated; and
a second address table in which a destination address of the packet is registered when the address table is defined as a first address table,
the tag terminator discarding a packet whose destination address is not registered in the second address table of the packets received from the time division demultiplexer.

8. The interface device as claimed in claim 7 wherein the tag terminator does not discard a broadcast packet from the time division demultiplexer.

9. The interface device as claimed in claim 7 wherein the tag generator registers a transmission source address of a packet in the second address table.

10. The interface device as claimed in claim 1, further comprising a port group management table in which a group identifier is associated with a port identifier,
the address table further storing a group identifier associated with the destination address,
the tag generator further referring to the address table, and adding the group identifier corresponding to the destination address of the received packet to the packet, and
the time division multiplexer referring to the port group management table, and transmitting the packet to the time division multiplexing channels corresponding to all port identifiers associated with the group identifiers added to the packet.

11. The interface device as claimed in claim 1, further comprising:
a port group management table in which a group identifier is associated with a port identifier, and
the time division multiplexer referring to the port group management table, and transmitting the packet to time division multiplexing channels corresponding to all port identifiers associated with a group identifier added to a received packet.

12. The interface device as claimed in claim 6, further comprising a port group management table in which a group identifier is associated with a port identifier,
the address table further storing the group identifier associated with the destination address,
the time division demultiplexer referring to the port group management table, and further adding, to the packet, the group identifier corresponding to the port identifier, and
the tag terminator associating a transmission source address of the packet with the added group identifier to be registered or updated in the address table.

13. The interface device as claimed in claim 7 wherein the tag terminator does not discard a multicast packet from the time division demultiplexer.

14. The interface device as claimed in claim 1, further comprising, when the time division multiplexer is defined as a first time division multiplexer, a second time division multiplexer for time-division-multiplexing time division multiplexing channels from a plurality of first time division multiplexers.

15. The interface device as claimed in claim 6, further comprising, when the time division demultiplexer is defined as a first time division demultiplexer, a second time division demultiplexer at a preceding stage of the first time division demultiplexer, and a packet multiplexer between the first time division demultiplexer and the tag terminator.

16. The interface device as claimed in claim 1 wherein the time division multiplexing channel comprises a PDH channel or an SDH channel.

17. A network system comprising:
a first packet multiplexing network;
a first interface device according to claim 1 connected to the first packet multiplexing network;
a time division multiplexing channel network connected to the first interface device;
a second interface device according to claim 1 connected to the time division multiplexing channel network; and
a second packet multiplexing network connected to the second interface device.
